(19) United States
(12) Patent Application Publication
(10) Pub. No.: US 2007/0264000 A1
(43) Pub. Date: Nov. 15, 2007

(54) Image Extraction Apparatus and Flash Control Method for Same

(75) Inventors: Wen-Hung Hsieh, Jubei City (TW); Ching-Jung Tsai, Taichung (TW); Ming-Chang Lai, Taichung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASIA OPTICAL CO., INC., Taichung (TW)

(21) Appl. No.: 11/742,021

(22) Filed: Apr. 30, 2007

(30) Foreign Application Priority Data
May 15, 2006 (TW) 95117148

(51) Int. Cl. G03B 15/03

(52) U.S. Cl. 396/157

(57) ABSTRACT

An image extraction apparatus and flash control method for the same are provided. The method comprises taking a reference image, generates a first flash, and takes a first image. The first image is determined to be is overexposed or not. If the first image is not overexposed, a first flash parameter is set according to the first image. If so, a second flash is generated and a second image is taken. The second image is determined to be overexposed or not. If the second image is not overexposed, a second flash parameter is set according to the second image. If the second image is overexposed, a third flash parameter is set according to the reference image. Finally, a final flash is generated according to the first, second, or third flash parameter to obtain the desired image.

### RELATED APPLICATIONS

The application claims priority to Taiwan Application Serial Number 95117148, filed May 15, 2006, which is herein incorporated by reference.

### BACKGROUND

1. Field of Invention

The present invention relates to an image extraction apparatus and a flash control method for the same. More particularly, the present invention relates to an image extraction apparatus and a method for controlling the flash intensity thereof.

2. Description of Related Art

Owing to complex environmental factors such as object brightness and background light source, overexposure and underexposure frequently occur in pictures taken with a digital camera. In general, the digital camera may take a reference image before flash, and determine a flash parameter to calculate the flash intensity and flash period in accordance with the reference image, then take a picture with the calculated predetermined flash parameter. However, using this method does not allow the brightness of the exposed object to be accurately determined and consequently leads to overexposure or underexposure of the picture.

For the forgoing reasons, there is a need to provide more information about the brightness of an object to accurately determine the exposure.

### SUMMARY

The present invention employs a dual pre-flash metering system to adjust the flash intensity and determine an appropriate exposure for a digital camera that satisfies the need of provide more information about the brightness of an object. The method includes taking a reference image from an object, flashing a first flash and a second flash, and taking a first image and a second image from the object respectively. The first image determines whether the object is overexposure or not. If first image is not overexposed, a first primary flashing parameter is set in accordance with the flash intensity of the first image. If the first image is overexposed and the second image is not overexposed, a second primary flashing parameter is set in accordance with the flash intensity of the second image. And further, in the case both the first image and the second image are overexposed, a third primary flashing parameter is set in accordance with the flash intensity of the reference image. Finally, a final flash is flashed in accordance with the first primary flashing parameter, the second primary flashing parameter, or the third primary flashing parameter to obtain the desired image.

It is another aspect of the present invention to provide a flash control method for applying to an image extraction apparatus. The method includes executing a focusing operation in accordance with a signal obtained from the image extraction apparatus, and takes a reference image from an object following the focusing operation. The image extraction apparatus flashes a first flash and takes a first image, then determines the first exposure result of the plurality of image squares of the first image in accordance with the image definition to determine whether the first image is overexposed or not. If the first image is not overexposed, a first primary flashing parameter is set in accordance with the flash intensity of the first image. If the first image is overexposed, the image extraction apparatus flashes a second flash and takes a second image, then determines the second exposure result for the plurality of image squares of the second image in accordance with an image definition to determine whether the second image is overexposed or not. If the second image is not overexposed, a second primary flashing parameter is set in accordance with the flash intensity of the second image. If the second image is overexposed, a third primary flashing parameter is set in accordance with the flash intensity of the reference image. Finally, a final flash is flashed in accordance with the first primary flashing parameter, the second primary flashing parameter, or the third primary flashing parameter to obtain the desired image.

It is still another aspect of the present invention to provide an image extraction apparatus comprising a flash system, a camera shutter, a camera lens, an image sensing unit, a memory, a drive system, a digital signal-processing unit and a microprocessor. The memory stores the image signal. The drive system drives the camera lens or the image sensing unit to a focusing position of the camera. The image sensing unit takes an image signal. The digital signal-processing unit collects, calculates and generates image signals.

After the microprocessor receives a shutter signal from the camera shutter, the drive system drives the camera module or the image sensing unit to focus the camera, and then take a reference image of an object with the image sensing unit, and flashes a first flash from the flash system. A first image is then taken by the image sensing unit and delivers the first image to the microprocessor.

The microprocessor determines the first exposure result of the plurality of image squares for the first image in accordance with an image definition and determines whether the first image is overexposed or not. If the first image is not overexposed, a first primary flashing parameter is set in accordance with the first image. If the first image is overexposed, the flash system flashes a second flash, and then takes a second image with the image sensing unit and delivers the third image to the digital signal-processing unit of the microprocessor.

The first exposure result of the plurality image squares of the first image is determined by the digital signal-processing unit in accordance with the image definition, and whether the first image is overexposed or not is determined. If the first image is not overexposed, a first primary flashing parameter is set in accordance with the first image. If the first image is overexposed, a second flash is flashed and a second image is taken with the image extraction apparatus.

The second exposure result of the plurality of image squares of the second image are determined by the digital signal-processing unit in accordance with the image definition, and whether the second image is overexposed or not is determined. If the second image is not overexposed, a second primary flashing parameter is set in accordance with the second image. If the second image is overexposed, a third primary flashing parameter is set in accordance with the reference image. A final flash is flashed in accordance with the first primary flashing parameter, the second primary flashing parameter, or the third primary flashing parameter to take a final image and store the final image in the memory.

### BRIEF DESCRIPTION OF THE DRAWINGS

These and other features, aspects, and advantages of the present invention will become better understood with regard to the following description, appended claims, and accompanying drawings where:

FIG. 1 is a flowchart of steps of an embodiment of the present invention; and

FIG. 2 is a diagram of the image squares according to one embodiment of this invention.

FIG. 3 is a block diagram of an image extraction apparatus of an embodiment of the present invention.

### DESCRIPTION OF THE PREFERRED EMBODIMENTS

Reference will now be made in detail to the present embodiments of the invention, examples of which are illustrated in the accompanying drawings. It is to be understood that the following disclosure provides many different embodiment, or examples, for implementing different features of the disclosure. Specific examples of components and arrangement are described below to simplify the present disclosure. These are, of course, merely examples and are not intended to be limiting. In addition, the present disclosure may repeat reference numerals and/or letters in the various examples. This repetition is for the purpose of simplicity and clarity and does not in it self dictate a relationship between the various embodiments and/or configurations discussed.

The embodiment of the present invention disclosed an image extraction apparatus and a flash control method for the same.

The method employs a dual pre-flash metering system to obtain different exposure information of an object by flashing two flashes with different intensities. The exposure information is used to determine a final flash parameter for accomplishing a final shoot. That is, before the final shoot, an image extraction apparatus (such as a digital camera) may flash two pre-test flashes with different intensities after the image extraction apparatus is focused, and obtains the image information of the two flashes respectively to adjust the intensity and period of the final flash.

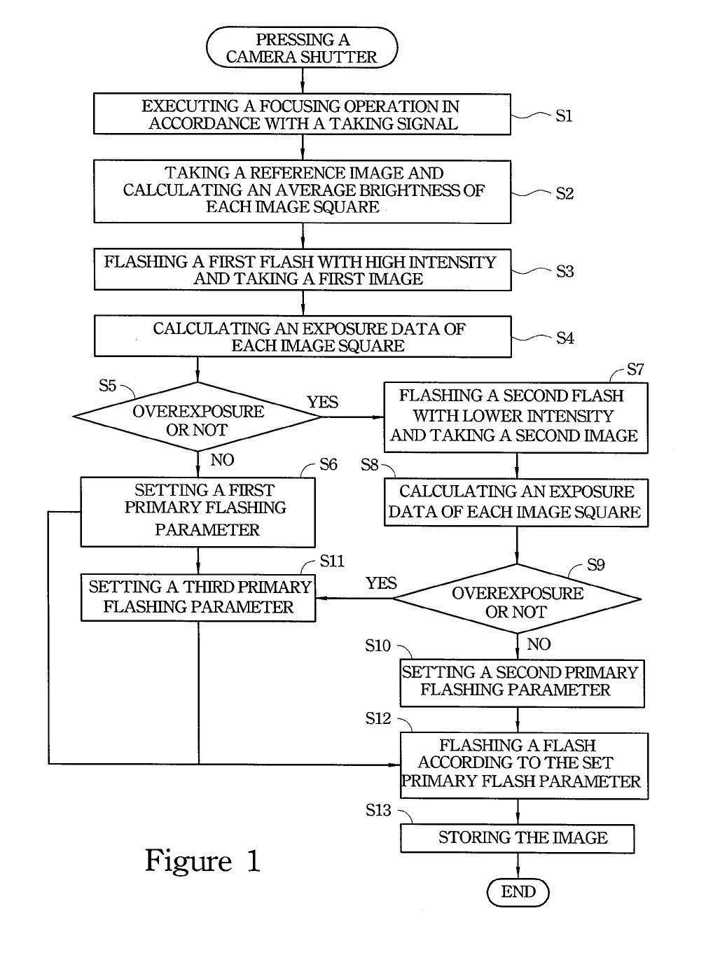

FIG. 1 is a flowchart of steps of an embodiment of the present invention.

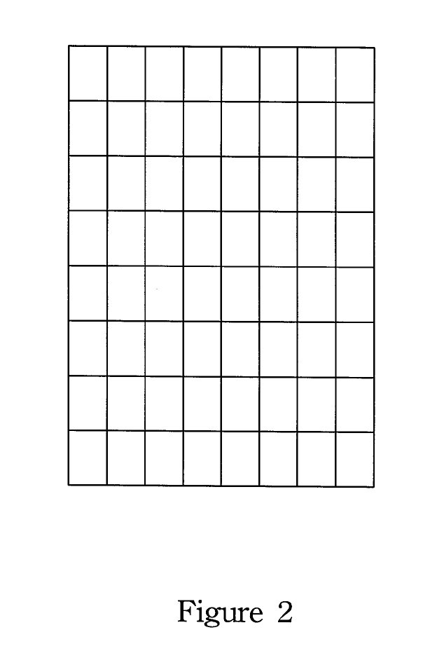

Before a shoot begins, a definition of the area of a desired image must be carried out. The image is divided into a plurality of image squares (for example, 64 image squares, as shown in FIG. 2), and the each image square is a unit of the image for exposure analysis.

First, in Step S1, the image extraction apparatus is focused and the camera shutter is then pressed so the picture (digital image) can be taken. In Step S2, after the focusing operation, the image extraction apparatus takes a reference image from an object, and executes an RGB-to-YUV transformation for all pixels of each image square of the image. The average brightness Y of each of the 64 image squares is calculated and denoted as Y1˜Y64. Further, the average brightness of each image square that is lighted up by the flash is calculated and denoted as FY1˜FY64. In Step S3, the flash system is started and flashes a high-intensity flash to take a first image. In Step S4, the exposure result of each image square of the first image is determined using the above-mentioned image definition. That is, the difference between the values of the average brightness (FYn−Yn) of the image squares of the first image before and after the flash. If the brightness difference (FYn−Yn) exceeds a predetermined brightness difference value (for example, 100), the image square is defined as overexposed. Whether the first image is overexposed or not is determined in step S5 by the amount of overexposed image squares that exceed a first specific amount (for example, 2). If the amount of the overexposed image squares is less than the pre-specified amount (for example 2), the first image is not overexposed. A first primary flashing parameter (for example, 1) is set in accordance with the flash intensity of first image in step S6. That is, a flash is flashed by the flash system in accordance with the first primary flashing parameter. If the amount of the overexposed image squares is larger than the pre-specified amount (for example 2), the first image is overexposed. A second flash with a lower intensity then the first flash is flashed by the flash system to obtain a second image in step S7. Exposure result of each image square of the second image is determined by using the above-mentioned image definition in step S8.

Whether the second image is overexposed or not is determined in step S9 by the amount of overexposed image squares that exceed a second specific amount (for example, 4). If the amount of the overexposed image squares is less than the pre-specified amount (for example 4), the second image is not overexposed. A second primary flashing parameter (for example, 2) is set in accordance with the flash intensity of second image (step S10). If the amount of the overexposed image squares is larger than the pre-specified amount (for example 4), the second image is overexposed. A third primary flashing parameter (for example, 3) is set in accordance with the flash intensity of reference image in step S11. That is, a flash is flashed by the flash system in accordance with the third primary flashing parameter.

Then, a final flash is flashed in accordance with the first primary flashing parameter, the second primary flashing parameter, or the third primary flashing parameter to obtain a desired image in step S12. In step S13 the image is saved in a memory.

The predetermined brightness difference value (100), the first specific amount, the second specific amount (2, 4), the primary flash parameter (1,2,3) and the number of the image squares are certain preferred embodiments thereof, other embodiments are possible. Therefore, it should not be limited to the present invention herein.

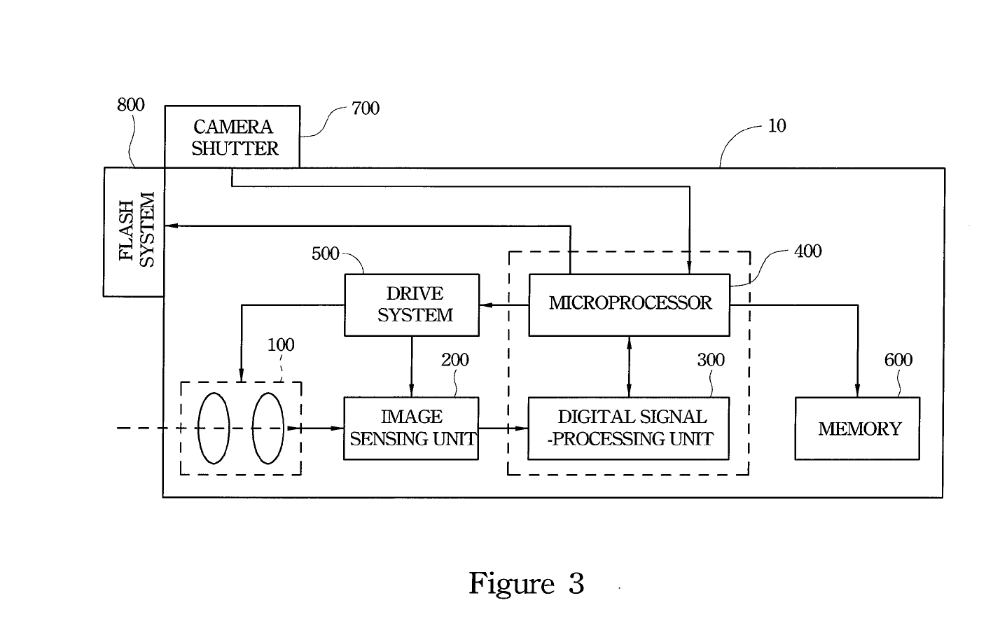

FIG. 3 is a block diagram of an image extraction apparatus of an embodiment of the present invention. The image extraction apparatus 10 includes a camera lens 100, an image sensing unit 200, a digital signal-processing (DSP) unit 300, a microprocessor 400, a drive system 500, a memory 600, a camera shutter 700 and a flash system 800. The camera lens 100 takes image signals from an object, and an image is displayed on the image sensing unit 200. The digital signal-processing unit 300 collects, calculates and generates image information. The drive system 500 is made by one of the motor, coil, driver unit or piezoelectric actuator to drive the camera lens 100 and the image sensing unit 200. The memory stores image signals.

As above-mentioned, a desired image is divided into 64 image squares (reference is made in FIG. 2) to define the image definition, and each image square is a basal unit for exposure analysis. A shutter signal is generated by pressing the camera shutter 700, and the signal is received by the microprocessor 400. The microprocessor 400 sends a control command to the image sensing unit 200 and the drive system 500 to make the drive system 500 drive the camera lens 100 or the image sensing unit 200 to execute a focusing operation and take a reference image from an object when the microprocessor 400 receives the shutter signal. An RGB-to-YUV transformation for all pixels of each image square of the image is then executed to determine the average brightness Y. The 64 image squares are denoted as Y1˜Y64. Further, the average brightness of each image square lighted up by flash is denoted as FY1˜FY64. The microprocessor 400 sends the control command to the flash system 800 to flash a first flash with a high intensity. After the first flash is completed, a first image is taken by the image sensing unit 200 and transformed into electric signals to the digital signal-processing unit 300.

The digital signal-processing unit 300 determines the exposure result of each image square of the first image is in accordance with the above-mentioned image definition. That is the brightness difference (FYn−Yn) between the image square of the first image before and after the first flash. If the brightness difference (FYn−Yn) exceeds a predetermined brightness difference value (100), the image square is defined as overexposed. The microprocessor 400 determines whether the first image is overexposed or not in accordance with the amount of the overexposed image squares that exceed a first specific amount (for example, 2). If the amount of the overexposed image squares is less than the pre-specified amount (for example 2) the first image is not overexposed. The microprocessor 400 sends another control command to the flash system 800 to flash a second flash with a low intensity. Following the second flash, a second image is taken by the image sensing unit 200 and transformed into electric signals sent to the digital signal-processing unit 300. The digital signal-processing unit 300 determines the exposure result of each image square of the second image in accordance with the above-mentioned image definition. Whether the second image is overexposed or not is determined according to the amount of overexposed image squares that exceed a second specific amount (for example, 4). If the amount of the overexposed image squares is less than the pre-specified amount (for example 4), the second image is not overexposed. The digital signal-processing unit 300 determines a second primary flashing parameter (for example 2) and sends second primary flashing parameter to the microprocessor 400. If the amount of the overexposed image squares is larger than the pre-specified amount, the second image is overexposed. The digital signal-processing unit 300 determines a third primary flashing parameter (for example, 3) in accordance with the flash intensity of the reference image. The third primary flashing parameter is delivered to the microprocessor 400. Then, a final flash is flashed by the microprocessor 400 in accordance with the first primary flashing parameter, the second primary flashing parameter, or the third primary flashing parameter to obtain a desired image. The image is saved in the memory 600.

Furthermore, in another embodiment of the present invention, the digital signal-processing unit 300 may be integrated with the microprocessor 400.

The embodiments of the present invention provide the dual pre-flash metering system applied to varied environments and objects. The dual pre-flash metering system can collect more information about the brightness of an exposed object so as to adjust the flash intensity and accomplish an appropriate exposure to prevent overexposure or underexposure occuring in pictures.

Although the present invention has been described in considerable detail with reference to certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A flash control method for an image extraction apparatus, the method comprising:
taking a reference image from an object;
flashing a first flash with a first period and a second flash with a second period, and taking a first image and a second image from the object in the first period and second period respectively;
determining whether the first image and the second image is overexposed;
setting a first primary flashing parameter in accordance with the first image when the first image is not overexposed;
setting a second primary flashing parameter in accordance with the second image when the first image is overexposed and the second image is not overexposed;
setting a third primary flashing parameter in accordance with the reference image when both the first image and the second image are overexposed; and
flashing a final flash in accordance with one of the first primary flashing parameter, the second primary flashing parameter, and the third primary flashing parameter.

2. The method of claim 1, further comprising dividing one of the first image and the second image into a plurality of image squares in accordance with an image definition, and determining whether the one of the first image and the second image is overexposed in accordance with each associated overexposed image square.

3. The method of claim 2, wherein the one of the first image and the second image is defined as overexposed by an amount of overexposed image squares that exceeds a specific amount.

4. The method of claim 3, further comprising defining an image square as being overexposed when a brightness difference between each image square of the reference image and the image square of the image extracted from the first period and second period exceeds a predetermined brightness difference value.

5. The method of claim 1, wherein an intensity of the first flash is greater than an intensity in the second flash.

6. A flash control method for an image extraction apparatus, and the method comprising:
executing a focusing operation in accordance with a signal obtained from a camera;
taking a reference image from an object following the focusing operation;
flashing a first flash with a first period and taking a first image;
determining a first exposure result of plurality of image squares of the first image in accordance with an image definition;
determining whether the first image is overexposed in accordance with the first exposure result;
setting a first primary flashing parameter in accordance with the first image when the first image is not overexposed;
flashing a second flash with a second period and taking a second image when the first image is overexposed;
determining a second exposure result of plurality of image squares of the second image in accordance with the image definition;
determining whether the second image is overexposed in accordance with the second exposure result;
setting a second primary flashing parameter in accordance with the second image when the second image is not overexposed;
setting a third primary flashing parameter in accordance with the second image when the second image is overexposed;
flashing a final flash and taking a final image in accordance with the first primary flashing parameter, the second primary flashing parameter, or the third primary flashing parameter.

7. The method of claim 6, further comprising dividing one of the first image and the second image into the plurality of image squares in accordance with the image definition, and where each image square is a basal unit for exposure analysis.

8. The method of claim 7, wherein the first image is defined as overexposed by an amount of the overexposed image squares that exceeds a first specific amount.

9. The method of claim 8, further comprising defining an image square as being overexposed when a brightness difference between each image square of the reference image and the image square of the image extracted from the first period and second period exceeds a predetermined brightness difference value.

10. The method of claim 6, wherein in the step of determining whether the second image is overexposed in accordance with the second exposure result, the second image is defined as overexposed by an amount of overexposed image squares that exceed a second specific amount.

11. The method of claim 10, further comprising defining an image square with overexposure as brightness difference between each image square of the reference image and the image square of the image extracted from the first period and second period.

12. The method of claim 6, wherein an intensity of the first flash is greater than an intensity of the second flash.

13. An image extraction apparatus, comprising:
a flash system;
a camera shutter;
a camera lens;
an image sensing unit coupled with the camera lens to take an image signal;
a memory for storing the image signal;
a drive system coupled with the camera lens and the image sensing unit to drive the camera lens and the image sensing unit to a focusing position of the camera;
a microprocessor coupled with the flash system, the camera shutter, the image sensing unit, and the memory to collect, calculate and generate image signals, after the microprocessor receives a shutter signal from the camera shutter, the drive system drives the camera lens and the image sensing unit to focus and take a reference image from an object using the image sensing unit so as to the flash system flashes a first flash with a first period and takes a first image with the image sensing unit and delivers the first image to the microprocessor,
the microprocessor determines a first exposure result of a plurality of image squares of the first imaged in accordance with an image definition and determines whether the first image is overexposed, if the first image is not overexposed, a first primary flashing parameter is set in accordance with the first image, if the first image is overexposed, a second flash is flashed with a second period by the flash system, and a second image is taken by the image sensing unit and delivered to the microprocessor,
the microprocessor determines a second exposure result of a plurality of image squares of the second imaged in accordance with an image definition and determines whether the second image is overexposed, if the second image is not overexposed, a second primary flashing parameter is set in accordance with the second image, if the second image is overexposed, a third primary flashing parameter is set in accordance with the reference image, a final flash is flashed in accordance with the first primary flashing parameter, the second primary flashing parameter, or the third primary flashing parameter to take a final image and store the final image in the memory.

14. The apparatus of claim 13, further comprising a digital signal-processing unit to calculate the first exposure result and the second exposure result in accordance with the image definition.

15. The apparatus of claim 13, wherein either the first image or the second image is divided into a plurality of image squares in accordance with the image definition, wherein each image square is a basal unit for exposure analysis.

16. The apparatus of claim 13, wherein the first image is defined as overexposed by that an amount of the overexposed image squares exceeds a first specific amount.

17. The apparatus of claim 16, wherein the second image is defined as overexposed by that an amount of the overexposed image squares exceeds a second specific amount.

18. The apparatus of claim 17, further comprising an image square is defined as overexposed when the brightness difference between each image square of the reference image and the image square of the image extracted from the first period and second period exceeds a predetermined brightness difference value.

19. The apparatus of claim 13, wherein an intensity of the first flash is greater than an intensity in the second flash.
